(19) United States
(12) Patent Application Publication
(10) Pub. No.: US 2021/0029196 A1
(43) Pub. Date: Jan. 28, 2021

(54) MANAGING A PUBLIC SERVICE ENDPOINT TO A WORKLOAD IN A PUBLIC CLOUD SYSTEM

(71) Applicant: Hewlett Packard Enterprise Development LP, Houston, TX (US)

(72) Inventors: Siva Subramaniam Manickam, Bangalore Karnataka (IN); Thavamaniraja Sakthivel, Bangalore Karnataka (IN); Vinnarasu Ganesan, Bangalore Karnataka (IN); Balaji Ramamoorthi, Bangalore Karnataka (IN)

(21) Appl. No.: 16/520,297

(22) Filed: Jul. 23, 2019

(51) Int. Cl. H04L 29/08; H04L 29/12

(52) U.S. Cl. CPC H04L 67/1008; H04L 67/1031; H04L 61/1511

(57) ABSTRACT

Examples described relate to managing a public service endpoint to a workload in a public cloud system. In an example, a determination may be made whether a public service endpoint to a workload in a public cloud system has not been accessed for a pre-defined period of time. In response to a determination that the public service endpoint to the workload in the public cloud system has not been accessed for the pre-defined period of time, the public service endpoint to the workload may be deleted. In response to a determination that an alias service endpoint associated with the public service endpoint has been accessed, a new public service endpoint may be associated with the workload in the public cloud system. Access to the workload in the public cloud system may be allowed via the new public service endpoint.

### BACKGROUND

The advent of cloud-based computing architectures has opened new possibilities for businesses. As a result, an increasing number of enterprises are adopting cloud computing based solutions. Generally speaking, cloud computing involves delivery of computing as a service rather than a product, whereby shared resources (software, storage resources, etc.) are provided to computing devices as a service. The resources are shared over a network such as the internet. Cloud computing thus provides a quick and scalable access to computing resources and information technology (IT) services.

### BRIEF DESCRIPTION OF THE DRAWINGS

For a better understanding of the solution, examples will now be described, with reference to the accompanying drawings, in which:

FIG. 1 is a block diagram of an example computing environment for managing a public service endpoint to a workload in a public cloud system;

FIG. 2 is a block diagram of an example public cloud system for managing a public service endpoint to a workload;

FIG. 3 is a flowchart of an example method of managing a public service endpoint to a workload in a public cloud system;

FIG. 4 is a flowchart of an example method of managing a public service endpoint to a workload in a public cloud system;

FIG. 5 is a block diagram of an example system including instructions in a machine-readable storage medium for managing a public service endpoint to a workload in a public cloud system.

### DETAILED DESCRIPTION

Cloud computing is a delivery model for technology-enabled services that provides on-demand and pay-as-you-use access to an elastic pool of shared computing resources. Some examples of such resources may include applications, servers, storage, networks, etc. Cloud computing allows rapid provisioning of computing resources that could be scaled up or down depending on the requirements of a customer. Thus, these assets may be consumed “as a service”.

One of the reasons behind the success of cloud computing is a technology called virtualization. Virtualization allows creation of a virtual version of a resource such as an operating system, a hardware platform, a storage resource etc. which may be shared, for instance, among different clients. Multiple virtual machines (VMs) may be created on a host device (for example, a server).

As used herein, the term “cloud system” (or “cloud”) may refer to an on-demand network access to a shared pool of information technology resources (e.g., networks, servers, storage, and/or applications) that can be quickly provisioned. A cloud system may include a public cloud (or a public cloud system), a private cloud (or a private cloud system), or a hybrid cloud (or a hybrid cloud system). To explain briefly, a cloud may be termed a public cloud if cloud computing services are rendered over a public network such as the internet. On the other hand, a private cloud is a proprietary network that supplies services to a specific set of users. A hybrid cloud combines private and public cloud services.

A cloud application deployed in a public cloud may be associated with a public endpoint. A public endpoint may include a unique domain name which is provided by a public cloud vendor. A public endpoint may be charged to a user, for example, on a per-hour basis. However, after they are deployed, all cloud workloads may not be accessed all the time and some workloads maybe infrequently accessed. Thus, the public endpoints associated with these infrequently accessed workloads may incur unnecessary operational costs. It may be useful if the less frequently accessed deployments could be identified and the public endpoints associated with them are efficiently managed.

To address these technical challenges, the present disclosure describes various examples for managing a public service endpoint to a workload in a public cloud system. In an example, a determination may be made whether a public service endpoint to a workload in a public cloud system has not been accessed for a pre-defined period of time. In response to a determination that the public service endpoint to the workload in the public cloud system has not been accessed for the pre-defined period of time, the public service endpoint to the workload in the public cloud system may be deleted. In response to a determination that an alias service endpoint associated with the public service endpoint has been accessed, a new public service endpoint may be associated with the workload in the public cloud system. Access to the workload in the public cloud system may be allowed via the new public service endpoint.

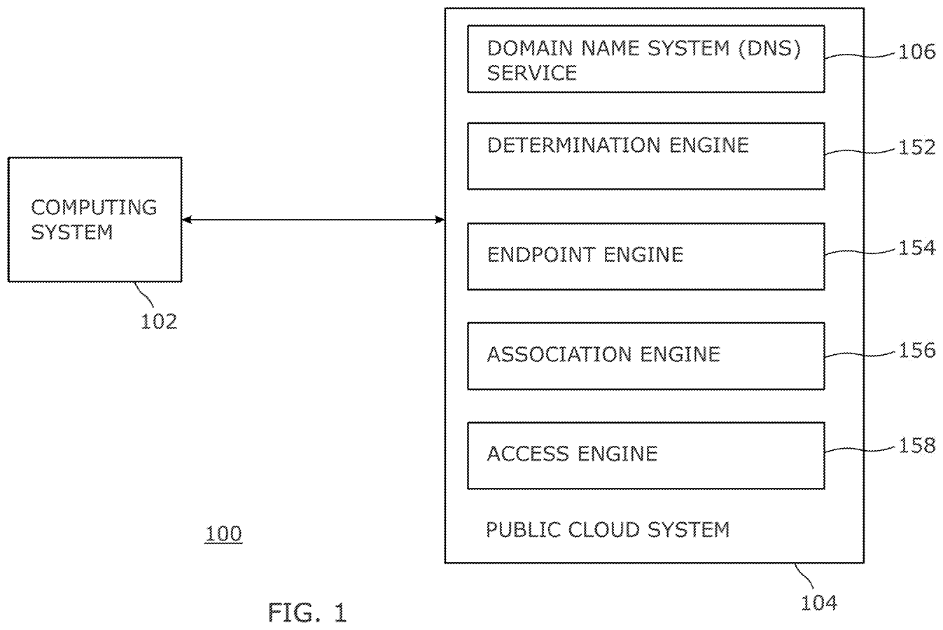

FIG. 1 is a block diagram of an example computing environment 100 for managing a public service endpoint to a workload in a public cloud system. In an example, computing environment 100 may include a computing system 102 and a public cloud system 104. Although one computing system and one public cloud system is shown in FIG. 1, other examples of this disclosure may include more than one computing system and more than one public cloud system.

In an example, computing system 102 may represent any type of computing device capable of reading machine-executable instructions. Examples of the computing device may include, without limitation, a server, a desktop computer, a notebook computer, a tablet computer, a thin client, a mobile device, and the like.

In an example, public cloud system 104 may include resources. As used herein, the “resources” in public cloud system 104 may refer to software resources (machine-executable instructions) or hardware resources. These may include, for example, computing resources, network resources, and/or storage resources. Computing resources may be a hardware computing resource (e.g., includes at least one processor). The hardware computing resource may represent any type of system capable of reading machine-executable instructions. Examples of the hardware computing resource may include a server, a desktop computer, a notebook computer, a tablet computer, a thin client, a mobile device, a personal digital assistant (PDA), and the like. In an example, computing resources may represent software resources (machine-executable instructions). The software resources may include, for example, operating system software, firmware, and application software. Other examples of the software resources may include virtual machines, virtual servers, load balancers, firewalls, etc. In an example, computing resources may be a combination of hardware and software resources.

Network resources may include a network device, a network software, or any combination thereof. Some non-limiting examples of the network device may include a hub, a network switch, a network router, a virtual switch, and a virtual router.

Storage resources may include a storage device, a storage software, or any combination thereof. The storage device may be an internal storage device, an external storage device, or a network attached storage device. Other examples of the storage device may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In other examples, the storage device may be a Direct Attached Storage (DAS) device, a Network Attached Storage (NAS) device, a Redundant Array of Inexpensive Disks (RAID), a data archival storage system, or a block-based device over a storage area network (SAN).

The resources may be accessed by users (for example, via computing system 102) or by applications, for example, for providing or deploying a cloud service. In an example, public cloud system 104 may provide or deploy various types of cloud services. These services may include, for example, Infrastructure as a Service (IaaS), Platform as a Service (PaaS), and Software as a Service (SaaS).

In an examples, the resources on public cloud system 104 may be used by users (for example, via computing system 102) to deploy a workload. As used herein, the term “workload” may refer to any machine-readable instructions executing on a computing resource. A “workload” may include, for example, a computer application, an operating system, a process, and an instruction.

In an example, in public cloud system 104, cloud resources (like servers and storage) may be owned and operated by a third-party cloud service provider and delivered over a network (e.g., the Internet). In an example, in public cloud system 104, cloud resources may be shared with other organizations. In an example, public cloud system 104 may be a hybrid cloud system. A hybrid cloud system combines private and public cloud services.

In an example, public cloud system 104 may include a determination engine 152, an endpoint engine 154, an association engine 156, and an access engine 158. In an example, determination engine 152, endpoint engine 154, association engine 156, and access engine 158 may be a part of a cloud management platform (e.g., machine-executable instructions). In an example, cloud management platform may be used by a user to deploy a workload on public cloud system 104.

Engines 152, 154, 156, and 158 may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one of engines 152, 154, 156, and 158. In some examples, the at least one machine-readable storage medium may store instructions that, when executed by the at least one processing resource, at least partially implement some or all of engines 152, 154, 156, and 158. In such examples, the public cloud system 104 may include the at least one machine-readable storage medium storing the instructions and the at least one processing resource to execute the instructions. In an example, public cloud system 104 may be any combination of hardware and programming.

In an example, a workload deployed on public cloud system 104 may be assigned a public service endpoint by, for example, the provider of cloud public system. A public service endpoint may provide a connection to a workload on public cloud system 104. In an example, a public service endpoint may include a unique domain name. In an example, the unique domain name may be assigned to a public service endpoint by a Domain Name System (DNS) service 106 on public cloud system 104. The Domain Name System (DNS) 106 is a distributed naming system for resources such as computers, services, etc. that are connected to the Internet or a private network. It may associate various information with domain names assigned to each of the participating entities, and translates domain names into IP addresses. A public service endpoint may be used by a user to access the associated workload on public cloud system 104, for example, via computing system 102. In an example, the DNS service 106 may create and associate an alias service endpoint with a public service endpoint in the public cloud system 104. Thus, an alias service endpoint is mapped to a public service endpoint by the DNS service 106. In an example, the alias service endpoint may be a domain name. In an example, an alias service endpoint may be used by a user to access the workload associated with the public service endpoint on public cloud system 104, for example, via computing system 102.

In an example, determination engine 152 may determine whether a public service endpoint to a workload in public cloud system 104 has not been accessed for a pre-defined period of time. The pre-defined period of time may be defined by a user. In an example, determination engine 152 may determine whether the public service endpoint to the workload in the public cloud system has not been accessed for the pre-defined period of time by periodically polling a DNS service (e.g., 106) on the public cloud system 104 that manages the public service endpoint. In response to a determination that the public service endpoint to the workload in public cloud system 104 has not been accessed for the pre-defined period of time, endpoint engine 154 may delete the public service endpoint to the workload. In an example, the deletion of a public service endpoint may be notified to a user by endpoint engine 154. In an example, the information related to the deleted public service endpoint and the associated workload may be stored in a database on the public cloud system 104.

If an alias service endpoint associated with the public service endpoint is accessed in future, for example, by a user, it indicates that the user is again interested in accessing the workload on public cloud system 104. In response, association engine 156 may associate a new public service endpoint with the workload in the public cloud system 104. In an example, associating the new public service endpoint with the workload in the public cloud system 104 may comprise creating the new public service endpoint. In an example, the new public service endpoint may be created by a Domain Name Service (DNS) service (e.g., 106) in the public cloud system 104. Once the new public service endpoint is created, association engine 156 may associate the new public service endpoint with the alias service endpoint. In an example, the new public service endpoint to the workload in public cloud system 104 may be created by a user. In an example, the new public service endpoint may be a domain name.

Once the new public service endpoint is associated with the alias service endpoint, access engine 158 may allow access to the workload in the public cloud system 104 via the new public service endpoint.

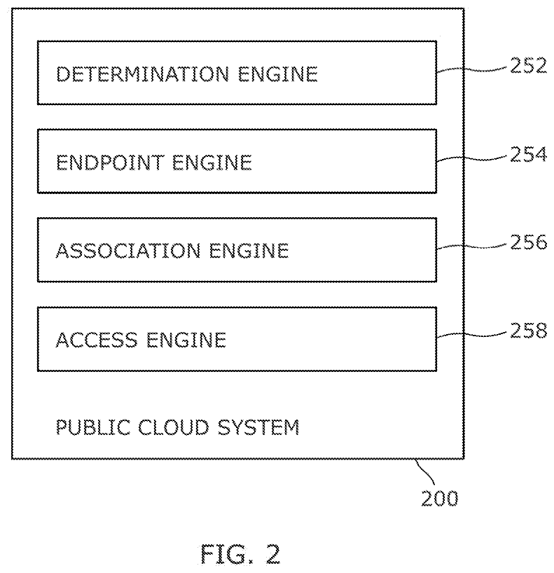

FIG. 2 is a block diagram of an example public cloud system 200. In an example, public cloud system 200 may be analogous to the public cloud system 104 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, public cloud system 200 may include a determination engine 252, an endpoint engine 254, an association engine 256, and an access engine 258. In an example, determination engine 252, endpoint engine 254, association engine 256, and access engine 258 may perform functionalities similar to those described earlier in reference to determination engine 152, endpoint engine 154, association engine 156, and access engine 158 of FIG. 1, respectively.

In an example, determination engine 252 may determine whether a public service endpoint to a workload in a public cloud system has not been accessed for a pre-defined period of time. In response to a determination that the public service endpoint to the workload in the public cloud system has not been accessed for the pre-defined period of time, endpoint engine 254 may delete the public service endpoint to the workload in the public cloud system. In response to a determination that an alias service endpoint associated with the public service endpoint has been accessed, association engine 256 may associate a new public service endpoint with the workload in the public cloud system. Access engine 258 may allow access to the workload in the public cloud system via the new public service endpoint.

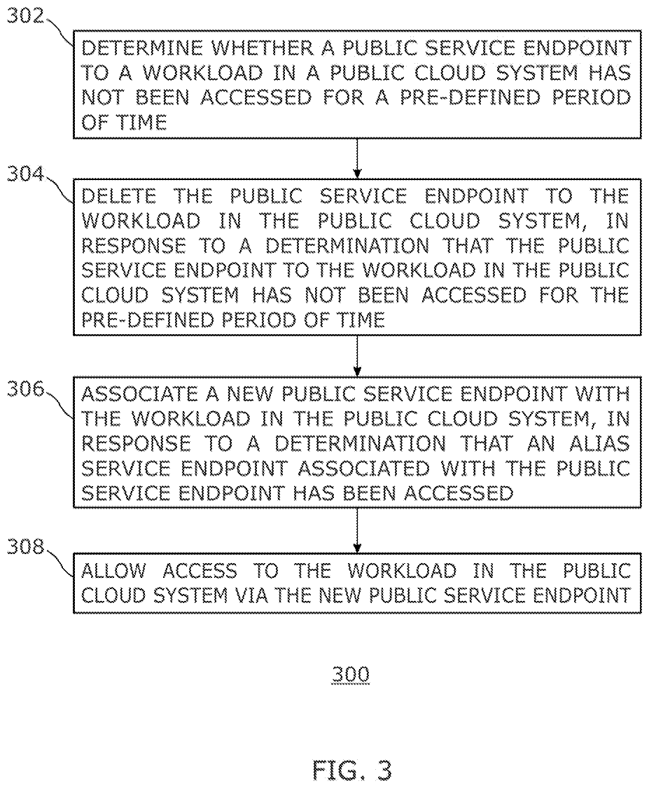

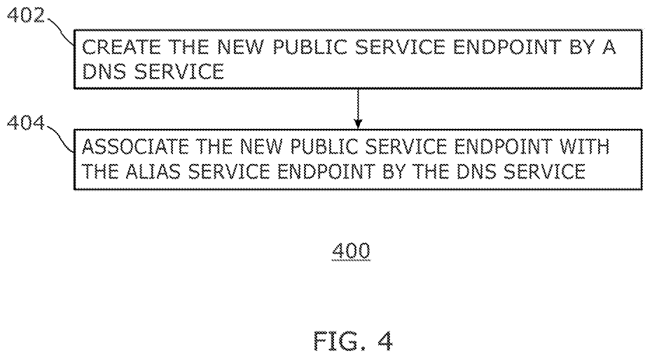

FIG. 3 is a flowchart of an example method 300 of managing a public service endpoint to a workload in a public cloud system. The method 300, which is described below, may be executed on a public cloud system such as public cloud system 104 of FIG. 1 or public cloud system 200 of FIG. 2. However, other computing platforms or computing devices may be used as well. At block 302, a determination may be made whether a public service endpoint to a workload in a public cloud system has not been accessed for a pre-defined period of time. At block 304, in response to a determination that the public service endpoint to the workload in the public cloud system has not been accessed for the pre-defined period of time, the public service endpoint to the workload in the public cloud system may be deleted. At block 306, in response to a determination that an alias service endpoint associated with the public service endpoint has been accessed, a new public service endpoint may be associated with the workload in the public cloud system. In an example, associating the new public service endpoint with the workload in the public cloud system may comprise creating the new public service endpoint by a DNS service on public cloud system. This is illustrated in block 402 of FIG. 4, which illustrates example method 400 of associating the new public service endpoint with the workload in the public cloud. At block 404, the new public service endpoint is associated with the alias service endpoint by the DNS service. Referring back to FIG. 3, at block 308, access to the workload in the public cloud system may be allowed via the new public service endpoint.

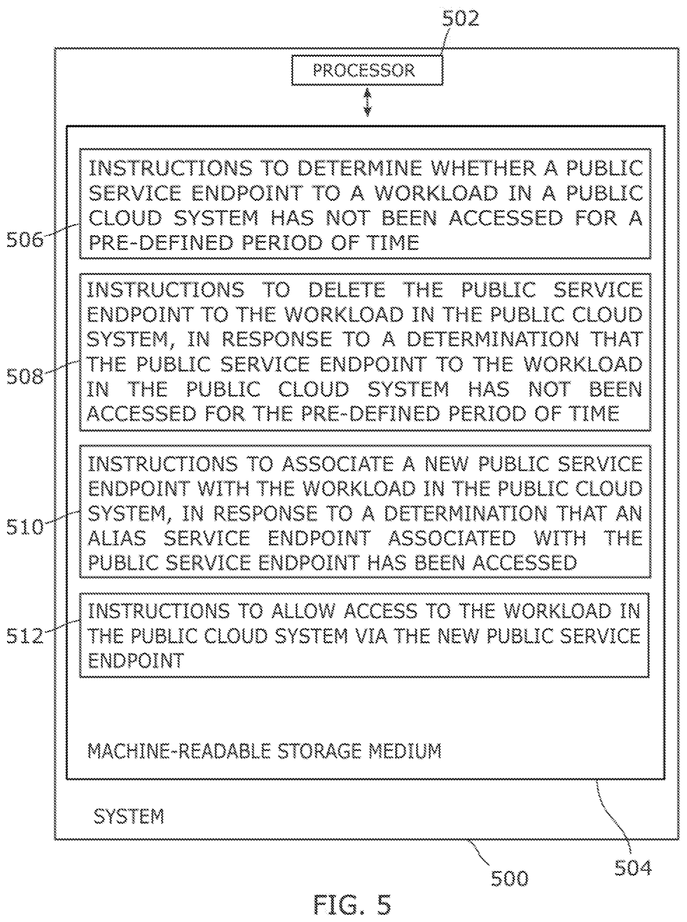

FIG. 5 is a block diagram of an example system 500 including instructions in a machine-readable storage medium for managing a public service endpoint to a workload in a public cloud system. System 500 includes a processor 502 and a machine-readable storage medium 504 communicatively coupled through a system bus. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 504 may store instructions 506, 508, 510, and 512.

In an example, instructions 506 may be executed by processor 502 to determine whether a public service endpoint to a workload in a public cloud system has not been accessed for a pre-defined period of time. Instructions 508 may be executed by processor 502 to delete the public service endpoint to the workload in the public cloud system, in response to a determination that the public service endpoint to the workload in the public cloud system has not been accessed for the pre-defined period of time. Instructions 510 may be executed by processor 502 to associate a new public service endpoint with the workload in the public cloud system, in response to a determination that an alias service endpoint associated with the public service endpoint has been accessed. Instructions 512 may be executed by processor 502 to allow access to the workload in the public cloud system via the new public service endpoint.

For the purpose of simplicity of explanation, the example methods of FIGS. 3 and 4 are shown as executing serially, however it is to be understood and appreciated that the present and other examples are not limited by the illustrated order. The example systems of FIGS. 1, 2, and 5, and methods of FIGS. 3 and 4 may be implemented in the form of a computer program product including computer-executable instructions, such as program code, which may be run on any suitable computing device in conjunction with a suitable operating system (for example, Microsoft Windows, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution.

1. A method, comprising:
determining whether a public service endpoint to a workload in a public cloud system has not been accessed for a pre-defined period of time;
in response to a determination that the public service endpoint to the workload in the public cloud system has not been accessed for the pre-defined period of time, deleting the public service endpoint to the workload in the public cloud system;
in response to a determination that an alias service endpoint associated with the public service endpoint has been accessed, associating a new public service endpoint with the workload in the public cloud system; and
allowing access to the workload in the public cloud system via the new public service endpoint.

2. The method of claim 1, wherein associating the new public service endpoint with the workload in the public cloud system comprises:
creating the new public service endpoint; and
associating the new public service endpoint with the alias service endpoint.

3. The method of claim 1, wherein associating the alias service endpoint with the public service endpoint comprises creating the alias service endpoint.

4. The method of claim 1, wherein the public service endpoint is a domain name.

5. The method of claim 1, wherein associating the alias service endpoint with the public service endpoint comprises creating the alias service endpoint by a Domain Name Service (DNS) service in the public cloud system.

6. The method of claim 1, wherein the public cloud system includes a hybrid cloud system.

7. The method of claim 1, wherein associating the new public service endpoint with the workload in the public cloud system comprises:
creating the new public service endpoint by a DNS service; and
associating the new public service endpoint with the alias service endpoint by the DNS service.

8. The method of claim 1, further comprising notifying a user regarding deletion of the public service endpoint.

9. A public cloud system, comprising:
a determination engine to determine whether a public service endpoint to a workload in the public cloud system has not been accessed for a pre-defined period of time;
an endpoint engine to, in response to a determination that the public service endpoint to the workload in the public cloud system has not been accessed for the pre-defined period of time, delete the public service endpoint to the workload in the public cloud system;
an association engine to, in response to a determination that an alias service endpoint associated with the public service endpoint has been accessed, associating a new public service endpoint with the workload in the public cloud system; and
an access engine to allow access to the workload in the public cloud system via the new public service endpoint.

10. The public cloud system of claim 9, wherein the alias service endpoint is a domain name.

11. The public cloud system of claim 9, wherein the new public service endpoint is associated with the workload in the public cloud system by a user.

12. The public cloud system of claim 9, wherein the new public service endpoint to the workload in the public cloud system is created by a user.

13. The public cloud system of claim 9, wherein the determination engine to determine whether the public service endpoint to the workload in the public cloud system has not been accessed for the pre-defined period of time by periodically polling a DNS service on the public cloud system that manages the public service endpoint.

14. A non-transitory machine-readable storage medium comprising instructions, the instructions executable by a processor to:
determine whether a public service endpoint to a workload in a public cloud system has not been accessed for a pre-defined period of time;
delete the public service endpoint to the workload in the public cloud system, in response to a determination that the public service endpoint to the workload in the public cloud system has not been accessed for the pre-defined period of time;
associate a new public service endpoint with the workload in the public cloud system, in response to a determination that an alias service endpoint associated with the public service endpoint has been accessed; and
allow access to the workload in the public cloud system via the new public service endpoint.

15. The storage medium of claim 14, wherein instructions to associate the alias service endpoint with the public service endpoint comprise instructions to create the alias service endpoint by a Domain Name System (DNS) service.

16. The storage medium of claim 14, wherein the public cloud system includes a hybrid cloud system.

17. The storage medium of claim 14, wherein instructions to associate the alias service endpoint with the public service endpoint comprises instructions to create the alias service endpoint in the public cloud system.

18. The storage medium of claim 14, wherein the new public service endpoint is a domain name.

19. The storage medium of claim 14, wherein information related to the deleted public service endpoint is maintained in a database.

20. The storage medium of claim 19, wherein the database is present on the public cloud system.
